(19) United States
(12) Patent Application Publication
(10) Pub. No.: US 2023/0076464 A1
(43) Pub. Date: Mar. 9, 2023

(54) HUMIDITY CONDITIONING MATERIAL, HUMIDITY CONDITIONING DEVICE, AND METHOD FOR MANUFACTURING HUMIDITY CONDITIONING MATERIAL

(71) Applicant: SHARP KABUSHIKI KAISHA, Sakai City, Osaka (JP)

(72) Inventors: KYOKO MATSUURA, Sakai City, Osaka (JP); Yuusuke SHIMIZU, Sakai City, Osaka (JP); TSUYOSHI KAMADA, Sakai City, Osaka (JP); TETSUYA IDE, Sakai City, Osaka (JP); SHO OCHI, Sakai City, Osaka (JP)

(21) Appl. No.: 17/800,126

(22) PCT Filed: Feb. 4, 2021
(86) PCT No.: PCT/JP2021/004005

§ 371 Date: Aug. 16, 2022

(30) Foreign Application Priority Data
Mar. 31, 2020 (JP) 2020-061939

(51) Int. Cl. B01D 53/26; B01D 53/28; B01J 20/04; B01J 20/22; B01J 20/30; G01N 31/22; F24F 3/14

(52) U.S. Cl. CPC B01D 53/261; B01D 53/28; B01J 20/04; B01J 20/22; B01J 20/30; G01N 31/22; F24F 3/1411

(57) ABSTRACT

Provided is a humidity conditioning material with which an amount of absorbed moisture or an amount of released moisture is easily understood. Moreover, provided is a humidity conditioning device including the above humidity conditioning material. Furthermore, provided is a method for manufacturing a humidity conditioning material with which an amount of absorbed moisture or an amount of released moisture is easily understood, and the humidity conditioning material has high humidity conditioning performance. In addition, the humidity conditioning material includes: a humidity conditioning liquid containing a hygroscopic substance; and a holding portion holding the humidity conditioning liquid into a predetermined shape. The holding portion is formed of a polymeric material. The hygroscopic substance contains a hygroscopic metal salt. The humidity conditioning liquid contains a pH indicator, and changes in color in accordance with an amount of moisture contained in the humidity conditioning liquid.

### TECHNICAL FIELD

The present invention relates to a humidity conditioning material, a humidity conditioning device, and a method for manufacturing the humidity conditioning material. The present application claims priority to Japanese Patent Application No. 2020-061939, filed on Mar. 31, 2020, the contents of which are incorporated herein by reference in its entirety.

### BACKGROUND ART

Conventionally, hygroscopic materials made of polymeric materials and formed into beads are known (see, for example, Patent Document 1). A hygroscopic material (hygroscopic millimeter-beads) described in Patent Document 1 is characterized by high hygroscopicity and small dimensional change upon absorbing and releasing moisture.

### CITATION LIST

### Patent Literature

[Patent Document 1]: Japanese Unexamined Patent Application Publication No. 2017-056404

### SUMMARY OF INVENTION

### Technical Problems

However, because of the above characteristic, it is difficult for a user who uses the above hygroscopic material to understand how much moisture the hygroscopic material has absorbed by the appearance of the hygroscopic material in use. Hence, for example, a problem of the hygroscopic material is that it is difficult for the user to understand when to replace the hygroscopic material.

In addition, regardless of the hygroscopic material described above, if the user could understand how much moisture has been absorbed by the moisture-absorbing material in use, the hygroscopic material would be easy to use. That is why improvement has been required of the hygroscopic material.

In view of the above circumstances, an aspect of the present invention is intended to provide a humidity conditioning material with which the amount of absorbed moisture or the amount of released moisture is easily understood. Moreover, another aspect of the present invention is intended to provide a humidity conditioning device including the above humidity conditioning material with which the amount of absorbed moisture or the amount of released moisture is easily understood. Furthermore, still another aspect of the present invention is intended to provide a method for manufacturing a humidity conditioning material with which the amount of absorbed moisture or the amount of released moisture is easily understood, and the humidity conditioning material has high humidity conditioning performance.

### Solution to Problems

In order to solve the above problems, an aspect of the present invention includes the configurations below.

[1] A humidity conditioning material, comprising: a humidity conditioning liquid containing a hygroscopic substance; and a holding portion holding the humidity conditioning liquid into a predetermined shape, wherein the holding portion is formed of a polymeric material, the hygroscopic substance contains a hygroscopic metal salt, and the humidity conditioning liquid contains a pH indicator, and changes in color in accordance with an amount of moisture contained in the humidity conditioning liquid.

[2] The humidity conditioning material according to [1], wherein the pH indicator includes: a first indicator; and a second indicator that exhibits color change in a transition range different from a transition range of the first indicator.

[3] The humidity conditioning material according to [1] or [2], wherein the humidity conditioning liquid contains two or more kinds of the hygroscopic substances.

[4] The humidity conditioning material according to [3], wherein the hydroscopic substance contains a hygroscopic polyalcohol and a hygroscopic metal salt.

[5] The humidity conditioning material according to any one of [1] to [4], wherein the predetermined shape is in a form of particles.

[6] The humidity conditioning material according to any one of [1] to [5], wherein the polymeric material is a water-absorbing polymer.

[7] The humidity conditioning material according to [5], wherein the humidity conditioning material has a core-shell structure including: a core containing the humidity conditioning liquid; and the holding portion formed of the polymeric material and shaped into a shell.

[8] A humidity conditioning device, comprising: the humidity conditioning material according to any one of [1] to [7]; and a housing portion housing the humidity conditioning material, wherein the housing portion is at least partially transparent to light.

[9] A method for manufacturing a humidity conditioning material, the method comprising: a step of preparing a humidity conditioning liquid; a step of obtaining a liquid mixture in which a polymeric material is mixed with the humidity conditioning liquid, the polymeric material reacting with a gelling agent to form a gel; a step of dripping the liquid mixture into the gelling agent to obtain particles; and a step of freeze-drying the particles.

### Advantageous Effects of Invention

An aspect of the present invention can provide a humidity conditioning material with which the amount of absorbed moisture or the amount of released moisture can be easily understood. Moreover, another aspect of the present invention can provide a humidity conditioning device including the above humidity conditioning material with which the amount of absorbed moisture or the amount of released moisture is easily understood. Furthermore, still another aspect of the present invention can provide a method for manufacturing a humidity conditioning material with which the amount of absorbed moisture or the amount of released moisture is easily understood, and the humidity conditioning material has high humidity conditioning performance.

### BRIEF DESCRIPTION OF DRAWINGS

FIG. 1 is a schematic view of a humidity conditioning material 1 according to a first embodiment of the present invention.

FIG. 2 is an illustration of a humidity conditioning material 2 according to a second embodiment of the present invention.

FIG. 3 is an illustration of a humidity conditioning device 100 according to a third embodiment of the present invention.

### DESCRIPTION OF EMBODIMENTS

### First Embodiment

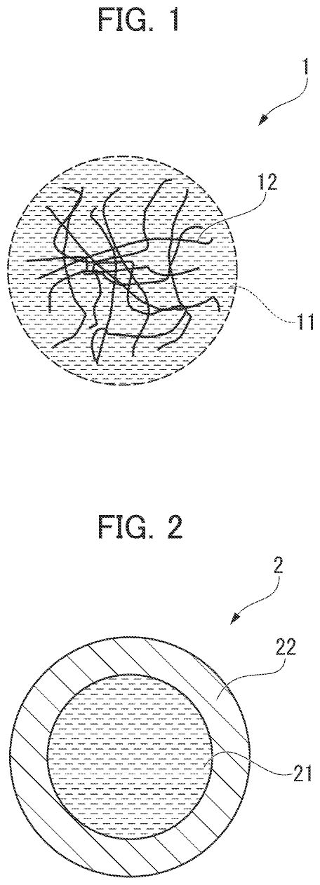

FIG. 1 is a schematic view of a humidity conditioning material 1 according to this embodiment. Note that, in all the drawings below, the constituent features vary in dimensions and proportions as appropriate so that the drawings are easy to see.

In this DESCRIPTION, the term “humidity conditioning” means to adjust the amount of water vapor contained in the air. The humidity conditioning includes both “moisture absorption” that involves removing water vapor in the air to relatively reduce the amount of the water vapor contained in the air, and “humidification” that involves supplying water vapor to the air to relatively increase the amount of the water vapor contained in the air.

The humidity conditioning material 1 according to this embodiment includes: a humidity conditioning liquid 11; and a holding portion 12 holding the humidity conditioning liquid 11. The humidity conditioning material 1 according to this embodiment is shaped into particles. Depending on the humidity of an environment in which the humidity conditioning material 1 is placed, the humidity conditioning material 1 takes up moisture by absorbing the moisture contained in the air in which the humidity conditioning material 1 is placed, or adds moisture by releasing in the air the moisture contained in the humidity conditioning material 1.

The humidity conditioning material 1 will be described below in sequence.

### <Humidity Conditioning Liquid>

The humidity conditioning liquid 11 included in the humidity conditioning material 1 has a property of absorbing moisture contained in the surrounding air (hygroscopicity) until the humidity conditioning liquid 11 reaches an equilibrium with the humidity of the air in which the humidity conditioning material 1 is placed, if the air in which the humidity conditioning material 1 is placed is relatively wet compared with the humidity conditioning liquid 11.

Moreover, the humidity conditioning liquid 11 has a property of releasing in the air moisture contained in the humidity conditioning liquid 11 until the humidity conditioning liquid 11 reaches an equilibrium with the humidity of the air in which the humidity conditioning material 1 is placed, if the air in which the humidity conditioning material 1 is placed is relatively dry compared with the humidity conditioning liquid.

Note that, also when heated, the humidity conditioning liquid 11 releases in the air moisture contained in the humidity conditioning liquid 11.

The humidity conditioning liquid 11 contains: a hygroscopic substance; and an indicator a color of which changes according to the amount of moisture contained in the humidity conditioning liquid 11.

### (Hygroscopic Substance)

The hygroscopic substance can include an organic material and an inorganic material.

Examples of the hygroscopic organic material to be used as the hygroscopic substance include divalent or more than divalent alcohols (polyalcohols), ketones, organic solvents having amide groups, saccharides, and known materials to be used as raw materials of moisturizing cosmetics. Among these materials, the organic materials to be preferably used as the hygroscopic substance include polyalcohols, organic solvents having amid groups, saccharides, and known materials to be used as raw materials of moisturizing cosmetics. Such organic materials are high in hydrophilicity.

Examples of the polyalcohols include glycerin, propanediol, butanediol, pentanediol, trimethylolpropane, butanetriol, ethylene glycol, diethylene glycol, and triethylene glycol. Moreover, the hygroscopic polyalcohols may be dimers or polymers of the polyalcohols.

Examples of the organic solvents having amid groups include formamide and acetamide.

Examples of the saccharides include sucrose, pullulan, glucose, xylol, fructose, mannitol, and sorbitol.

Examples of the known materials to be used as raw materials of moisturizing cosmetics include 2-methacryloyloxyethyl phosphorylcholine (MPC), betaine, hyaluronic acid, and collagen.

Examples of the hygroscopic inorganic material to be used as the hygroscopic substance include: chlorides such as calcium chloride, lithium chloride, magnesium chloride, potassium chloride, sodium chloride, zinc chloride, aluminum chloride, strontium chloride, and barium chloride;

bromides such as lithium bromide, calcium bromide, and potassium bromide;

nitrates such as magnesium nitrate, calcium nitrate, strontium nitrate, and barium nitrate; and

metal salts such as magnesium sulfate, sodium hydroxide, and sodium pyrrolidone carboxylic acid.

Among the metal salts, lithium chloride and calcium chloride are preferable.

The humidity conditioning liquid 11 preferably contains two or more kinds of hygroscopic substances. When the humidity conditioning liquid 11 contains two or more kinds of hygroscopic substances, physical properties of the humidity conditioning liquid 11 are easily adjusted.

If the humidity conditioning liquid 11 contains two or more kinds of hygroscopic substances, for example, two or more kinds of polyalcohols may be used, two or more kinds of metal salts may be used, or a polyalcohol and a metal salt may be used in combination.

The humidity conditioning liquid 11 preferably contains a hygroscopic polyalcohol and a hygroscopic metal salt.

As to a concentration of the humidity conditioning liquid, a preliminary experiment is conducted in advance so that the concentration to be obtained can exhibit target humidity conditioning performance.

For example, as the hygroscopic substance contained in the humidity conditioning liquid, if glycerin alone is used, a mixing ratio (a mass ratio) of glycerin to water is preferably in the range of (glycerin):(water)=90:10 to 25:75.

In such a range, when movement of the moisture (humidity conditioning) reaches an equilibrium between the humidity conditioning liquid and the surrounding air, the humidity conditioning liquid is more likely to change in pH depending on a difference in concentration of the humidity conditioning liquid, and the pH indicator is more likely to indicate a different color. Hence, it is easy to determine the humidity of the surrounding air that has reached an equilibrium in the movement of the moisture (humidity conditioning) with the humidity conditioning liquid.

### (Indicator)

As an indicator included in the humidity conditioning liquid 11 according to this embodiment, a pH indicator can be preferably used. The humidity conditioning liquid 11 changes in pH as concentration of the humidity conditioning liquid 11 changes in accordance with the amount of absorbed moisture. That is, the humidity conditioning liquid 11 changes in pH in accordance with the amount of absorbed moisture, or of released moisture. Hence, when the humidity conditioning liquid 11 includes the pH indicator, the humidity conditioning material 1 changes in color in accordance with the amount of moisture absorbed, or released, by the humidity conditioning liquid 11.

Moreover, the humidity conditioning material 1 according to this embodiment absorbs or releases moisture until the humidity conditioning material 1 reaches an equilibrium with the humidity of the air in which the humidity conditioning material 1 according to this embodiment is placed. Hence, when a correspondence relationship is examined in advance between the colors of the pH indicator and the humidity of the environment in which the humidity conditioning material 1 is placed, the humidity of the environment in which the humidity conditioning material 1 is placed can be understood in a simple manner by a color of the humidity conditioning material 1.

Examples of the pH indicator includes known pH indicators such as methyl yellow, bromophenol blue, congo red, methyl orange, bromocresol green, methyl red, litmus, bromocresol purple, bromothymol blue, phenol red, thymol blue, neutral red, cresol red litmus, paranitrophenol, methyl purple, and phenolphthalein.

Moreover, as the pH indicator, triarylmethane derivatives, fluoran derivatives, pyrazolone derivatives, azo derivatives, and xanthene derivatives can also be used.

The above pH indicator to be used may be of one kind alone. Alternatively, two or more kinds of the pH indicators may be used in combination. If two or more kinds of the pH indicators are used, for example, a first indicator and a second indicator that exhibits color change in a transition range different from a transition range of the first indicator may be used.

Moreover, if two or more kinds of pH indicators are used, a compound ratio at which the pH indicators are mixed for use can be a known ratio. For example, as an indicator included in the humidity conditioning liquid 11 of this embodiment, among the above pH indicators, a Yamada-type universal indicator (a universal pH indicator) containing thymol blue, methyl red, bromothymol blue, and phenolphthalein may be used. In the case of the Yamada-type universal indicator, among the four indicators constituting the Yamada-type universal indicator, one of the four indicators may be a “first indicator”, and another one may be a “second indicator”.

### (Other Substances)

Moreover, the humidity conditioning liquid 11 may contain a solvent as another substance. The solvent includes a solvent in which the above hygroscopic substance dissolves, or a solvent with which the hygroscopic substance is mixed. An example of such a solvent can include water.

Furthermore, as the solvent, the polyalcohol or the organic solvent mentioned above as the hygroscopic organic material may be used.

When the humidity conditioning liquid 11 contains the solvent, a mixing ratio (a mass ratio) of the solvent to the indicator is preferably in a range of (solvent):(indicator)=100:1 to 50:1.

In addition, the humidity conditioning liquid 11 may contain, as other substances, a dye for color adjustment, and a preservative to reduce growth of unwanted bacteria in the humidity conditioning liquid 11.

### <Holding Portion>

The holding portion 12 included in the humidity conditioning material 1 has a function of holding the humidity conditioning liquid 11 described above.

The holding portion 12 of this embodiment is formed of a known water-absorbing polymeric material (a water-absorbing polymer). Examples of the material for forming the holding portion 12 include polyacrylate, starch-acrylate graft polymer, vinyl acetate copolymer, maleic anhydride copolymer, and polyvinyl alcohol.

### <Method for Manufacturing Humidity Conditioning Material>

A method for manufacturing the humidity conditioning material 1 according to this embodiment can include a step of manufacturing the holding portion 12 and a step of swelling the humidity conditioning liquid 11 with the obtained holding portion 12.

In the step of manufacturing the holding portion 12, the holding portion 12 can be manufactured by a known inversed phase suspension polymerization technique. Specifically, the holding portion 12 can be manufactured of: a continuous phase such as a hydrophobic organic solvent containing a surfactant and a dispersant; and a disperse phase such as a liquid mixture containing a monomer including a repeating unit of the water-absorbing polymeric material described above, a polymerization initiator, and a crosslinking agent. The continuous phase and the liquid mixture are subjected to suspension polymerization to form the holding portion 12.

Examples of the monomer can include acrylic acid, vinyl acetate, vinyl alcohol, and maleic anhydride.

Examples of the polymerization initiator can include an organic peroxide and an azo compound, each known as a radical polymerization initiator.

The crosslinking agent is used to adjust the water absorption performance of the holding portion 12 to be obtained. The larger the amount of the crosslinking agent to be copolymerized with the monomer is, the denser the crosslinking of the polymeric material included in the holding portion 12 is, thereby decreasing the hygroscopicity. The smaller the amount of the crosslinking agent to be copolymerized with the monomer is, the coarser the crosslinking of the polymeric material included in the holding portion 12 is, thereby increasing the hygroscopicity.

Examples of the organic solvent as the continuous phase can include aliphatic hydrocarbons, alicyclic hydrocarbons, aromatic hydrocarbons, aliphatic alcohols, aliphatic ketones, and aliphatic esters.

The surfactant that can be used shall not be limited to a particular surfactant, and any of an anionic surfactant, a cationic surfactant, an amphoteric surfactant, and a nonionic surfactant can be used.

The dispersant shall not be limited to a particular dispersant as long as the dispersant can stably disperse the monomer in the organic solvent. The dispersant may be a known dispersant. Examples of the dispersant can include fatty acid ester, cellulose ether, and cellulose ester.

The holding portion 12 manufactured by the inversed phase suspension polymerization technique is preferably dried.

Note that, in the polymerization, silica (colloidal crystals) arranged regularly may be added to the holding portion 12. After the polymerization, the silica is etched and removed so that the holding portion 12 may be colored with a structural color. The holding portion 12 having the structural color can be manufactured in the same manner as a known technique of manufacturing an inverse opal gel.

Before immersed in the humidity conditioning liquid 11, the holding portion 12 may have a size (a diameter) of, for example, 1 mm or more and 30 mm or less. The size of the holding portion 12 can be controlled by changing at least one selected from the group consisting of the agitation speed, the amount of the surfactant, the amount of the dispersant, and the amount of the polymerization initiator in the above-mentioned inversed phase suspension polymerization.

In the step of swelling the humidity conditioning liquid 11 with the holding portion 12, the holding portion 12 shaped into particles is immersed in the humidity conditioning liquid 11 to swell. Hence, the humidity conditioning material 1 according to this embodiment can be manufactured.

The humidity conditioning material 1 obtained by immersing the holding portion 12 in the humidity conditioning liquid 11 become larger than the holding portion 12 before being immersed in the humidity conditioning liquid 11, because the humidity conditioning liquid 11 swells. For example, the humidity conditioning material 1 can have a size (a diameter) of 4 mm or more and 150 mm or less.

The humidity conditioning material 1 according to this embodiment absorbs moisture from the surrounding air when the air in which the humidity conditioning material 1 is placed is relatively wet compared with the humidity conditioning liquid 11. Moreover, the humidity conditioning material 1 releases, in the air, moisture contained in the humidity conditioning liquid 11 when the air in which the humidity conditioning material 1 is placed is relatively dry compared with the humidity conditioning liquid 11.

When the amount of the held moisture changes in this manner, the humidity conditioning liquid 11 included in the humidity conditioning material 1 changes in concentration, and in pH. As a result, the pH indicator included in the humidity conditioning liquid 11 exhibits color reaction, making it possible to detect that the humidity conditioning material 1 have absorbed moisture, or released in the air moisture contained therein. Moreover, in accordance with a color of the humidity conditioning material 1, the humidity in which the humidity conditioning material 1 is placed can be easily detected.

Furthermore, the humidity conditioning material 1 swells by absorbing moisture, and becomes larger in diameter than the humidity conditioning material 1 before absorbing the moisture. In addition, the humidity conditioning material 1 contracts by releasing, in the air, moisture contained in the humidity conditioning material 1 and humidifying the surrounding air, and becomes smaller in diameter than the humidity conditioning material 1 before humidifying the air. Hence, in accordance with the size of the humidity conditioning material 1, it is possible to detect that the humidity conditioning material 1 has absorbed moisture or released in the air moisture contained therein. Furthermore, in accordance with the size of the humidity conditioning material 1, it is possible to easily detect the humidity in which the humidity conditioning material 1 is placed.

A ratio of first particles 1A to second particles 1B that constitute the humidity conditioning material 1 may be set appropriately, in view of the colors of the first indicator and the second indicator to be used and of how easily the first particles 1A and the second particles 1B can be checked for the color change. For example, a mass ratio of the first particles 1A to the second particles 1B may be set as follows: (the first particles):(the second particles) may be 10:90 to 90:10, 25:75 to 75:25, or 40:60 to 60:40.

The humidity conditioning material 1 of the above-described configuration can be provided as a moisture absorbing material with which the amount of absorbed moisture and the amount of released moisture can be easily understood.

### Second Embodiment

FIG. 2 is an illustration of a humidity conditioning material 2 according to a second embodiment of the present invention. The humidity conditioning material 2 according to this embodiment includes: a humidity conditioning liquid 21; and a holding portion 22 holding the humidity conditioning liquid 21. The humidity conditioning material 2 according to this embodiment absorbs moisture contained in the air in which the humidity conditioning material 2 is placed, or releases in the air moisture contained in the humidity conditioning material 2, in accordance with the humidity of an environment in which the humidity conditioning material 2 is placed.

The humidity conditioning material 2 of this embodiment has a core-shell structure including: a core containing the humidity conditioning liquid 21; and a shell formed of a polymeric material.

### <Humidity Conditioning Liquid>

The humidity conditioning liquid 21 contains: a hygroscopic substance; and an indicator a color of which changes according to the amount of moisture contained in the humidity conditioning liquid 21: and a material to form the holding portion 22.

As the hygroscopic substance and the indicator, each of the substances exemplified in the first embodiment can be used.

The material for forming the holding portion 22 contained in the humidity conditioning liquid 21 will be described later.

### <Holding Portion>

The holding portion 22 corresponds to the shell of the humidity conditioning material 2 having a core-shell structure. The holding portion 22 is a hollow particle having a space to hold therein the humidity conditioning liquid 21.

The holding portion 22 can be formed of a polymeric material that reacts with a gelling agent to form a gel. Specifically, as the material for forming the holding portion 22, monovalent alginate, polysaccharides such as carboxymethyl cellulose and methyl cellulose, and polyalcohols such as polyvinyl alcohol can be used.

In this DESCRIPTION, the above materials to be used as the materials for forming the holding portion 22 are not included in the “water-absorbing polymer”; that is, a material for forming the holding portion 12.

The gelling agent, which reacts with the above polymeric material so that the polymeric material forms a gel, includes a polyvalent metal salt aqueous solution, an acidic aqueous solution, and a sodium tetraborate aqueous solution.

The polyvalent metal salt includes polyvalent metal ion salts such as calcium salts, magnesium salts, barium salts, and aluminum salts.

Combinations of the gel-forming polymeric material and the gelling agent include the following:

(1) a combination of monovalent alginate and a polyvalent metal salt solution;
(2) a combination of monovalent alginate and an acidic aqueous solution;
(3) a combination of (carboxy) methyl cellulose and a polyvalent metal salt solution; and
(4) a combination of polyvinyl alcohol and a sodium tetraborate aqueous solution.

Note that the “(carboxy) methyl cellulose” means both methyl cellulose and carboxymethyl cellulose.

The holding portion 22 may contain the above humidity conditioning liquid.

The holding portion 22 is permeable to moisture.

### <Method for Manufacturing Humidity Conditioning Material>

A method for manufacturing the humidity conditioning material according to this embodiment includes a step of preparing a humidity conditioning liquid, a step of obtaining a liquid mixture in which a material for forming the holding portion is mixed with the humidity conditioning liquid, and a step of dripping the liquid mixture into a gelling agent.

The step of preparing the humidity conditioning liquid involves mixing together the hygroscopic substance, the indicator, the solvent, and another substance, all of which are described above.

The step of obtaining the liquid mixture involves mixing an aqueous solution, which is separately prepared to contain a material for forming the holding portion, with the humidity conditioning liquid. For example, in the case where sodium alginate is used as the material for forming the holding portion, a sodium alginate aqueous solution of, in mass percent, 1% or more and 5% or less is prepared and mixed with the humidity conditioning liquid.

A proportion of the humidity conditioning liquid to the whole liquid mixture can be, in mass percent, 10% or more and 90% or less.

The step of dripping the liquid mixture into the gelling agent involves dripping the obtained liquid mixture into a galling agent aqueous solution. In the case where sodium alginate is used as the material for forming the holding portion, for example, a calcium chloride aqueous solution is used as the gelling agent. A concentration of the calcium chloride aqueous solution can be, in mass percent, 1% or more and 10% or less, for example.

When the liquid mixture is dripped into the gelling agent, the sodium alginate contained in the surface of a droplet of the dripped liquid mixture reacts with the gelling agent to form a gel. As a result, the gelled surface of the droplet becomes the shell (the holding portion 22) of the humidity conditioning material 2; and the non-gelled interior of the droplet becomes the core of the humidity conditioning material 2.

After dripping the liquid mixture into the gelling agent, the particles to be obtained may be removed from the gelling agent within 24 hours. This feature can reduce a problem of which the gelling agent penetrates into the center of a first particle 2A and a second particle 2B such that the particles are entirely gelled. The time period for removing the first particle 2A and the second particle 2B may be changed in accordance with the composition and the size of the particles after a preliminary experiment is conducted in advance and a time period during which no problem occurs is checked.

Moreover, the method may include a step of freeze-drying the particles obtained at the step of dripping the liquid mixture into the gelling agent. The freeze-drying involves freezing the above particles, and, after that, sublimating frozen moisture in a reduced pressure environment. Hence, the moisture in the holding portion is partially removed, and the portions from which the moisture is removed are deemed pores. As a result, the particles after the freeze-drying are deemed wider in surface area than the particles before the freeze-drying, and the obtained particles (the humidity conditioning material 2) are deemed more likely to absorb moisture than the particles before the freeze-drying.

Furthermore, the freeze-drying can also be expected to have an advantageous effect of cutting off a portion of the polymeric material included in the holding portion 22 to reduce the molecular weight of the polymeric material. Hence, the cross-linking of the polymeric material included in the holding portion 22 becomes coarse, thereby increasing the hygroscopicity.

The humidity conditioning material 2 of the above-described configuration can also be provided as a humidity conditioning material with which the amount of absorbed moisture or the amount of released moisture is easily understood.

Note that, in this embodiment, both the first particle 2A and the second particle 2B have a core-shell structure; however, the first particle 2A and the second particle 2B shall not be limited to have such a structure. The first particle 2A may have the core-shell structure described in the second embodiment, and the second particle 2B may have the same structure as the structure of the second particle 1B described in the first embodiment.

In the description below, the particles described in the first embodiment are referred to as “swollen particles”. Moreover, the particles described in the second embodiment are referred to as “core-shell particles”.

A ratio of the swollen particles to the core-shell particles included in the humidity conditioning material may be set appropriately. For example, a mass ratio of the swollen particles to the core-shell particles may be set as follows: (the swollen particles):(the core-shell particles) may be 10:90 to 90:10, 25:75 to 75:25, or 40:60 to 60:40.

### Third Embodiment

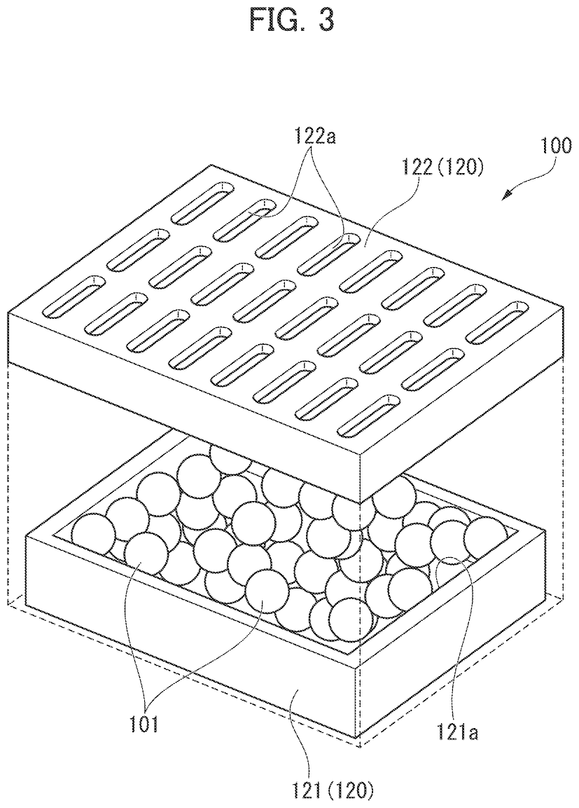

FIG. 3 is an illustration of a humidity conditioning device 100 according to a third embodiment of the present invention.

The humidity conditioning device 100 according to this embodiment includes: a humidity conditioning material 110; and a housing portion 120. The housing portion 120 includes: a container 121; and a lid 122.

As the humidity conditioning material 110, either the humidity conditioning material 1 or the humidity conditioning material 2 described above may be employed. The humidity conditioning material 110 is filled in the container 121.

The container 121 includes an internal space for filling the humidity conditioning material 110, and an upper portion of the container 121 is open to have an opening portion 121a. The container 121 illustrated in FIG. 3 is a flat thin container having a rectangular shape in plan view and a height direction dimension smaller than a plane direction dimension.

The container 121 is preferably transparent to light so that a state of the humidity conditioning material 110 can be visually recognized. As a material for forming the container 121, a light-transparent material can be preferably used. For example, as the material for forming the container 121, a known polymeric material such as glass, polystyrene, polyolefin, polyethylene terephthalate (PET), polymethyl methacrylate (PMMA), or polyvinyl chloride (PVC) can be used.

The container 121 may be totally, or only partially, transparent to light.

The lid 122 covers the container 121 from above the container 121 to close the opening portion 121a. As a result, the housing portion 120 houses the humidity conditioning material 110 inside the housing portion 120.

The lid 122 includes a plurality of through holes 112a penetrating the lid 122 in the thickness direction. Through the through holes 122a, the air in which the humidity conditioning device 100 is placed flows into, and out of, the housing portion 120.

A size of the through holes 122a can be set appropriately as long as the humidity conditioning material 110 cannot pass through the through holes 122a, and as long as the air flow is not obstructed. Moreover, the shape of the through holes 122a in plan view can also be set appropriately as long as the function of the through holes 122a is not obstructed.

The lid 122 may or may not be transparent to light.

As a material for forming the lid 122, a polymeric material can be preferably used.

The above humidity conditioning device 100 includes the humidity conditioning material described above. With the humidity conditioning device 100, it is easy to understand the amount of absorbed moisture or the amount of released moisture.

Although preferred embodiments according to the present invention have been described above with reference to the accompanying drawings, it is needless to say that the present invention is not limited to such embodiments. Various shapes and combinations of the constituent members shown in the examples described above are merely examples, and can be modified in various manners in accordance with design requirements unless otherwise departing from the subject matter of the present invention.

For example, in the embodiments described above, the humidity conditioning materials are shaped into particles. However, the shape of the humidity conditioning materials is not limited to a particular shape. The humidity conditioning materials may be shaped into various kinds of shapes as long as the humidity conditioning material is shaped into a predetermined shape to hold a humidity conditioning liquid.

1. A humidity conditioning material, comprising:
a humidity conditioning liquid containing a hygroscopic substance; and
a holding portion holding the humidity conditioning liquid into a predetermined shape,
wherein the holding portion is formed of a polymeric material,
the hygroscopic substance contains a hygroscopic metal salt, and
the humidity conditioning liquid contains a pH indicator configured to change in color in accordance with a concentration of the hygroscopic substance with respect to an amount of moisture contained in the humidity conditioning liquid, wherein
the color changes in accordance with an increase or decrease in the concentration.

2. The humidity conditioning material according to claim 1,
wherein the pH indicator includes: a first indicator; and a second indicator that exhibits color change in a transition range different from a transition range of the first indicator.

3. The humidity conditioning material according to claim 1,
wherein the humidity conditioning liquid contains two or more kinds of the hygroscopic substances.

4. The humidity conditioning material according to claim 3,
wherein the hydroscopic substance contains a hygroscopic polyalcohol and a hygroscopic metal salt.

5. The humidity conditioning material according to claim 1,
wherein the predetermined shape is in a form of particles.

6. The humidity conditioning material according to claim 1,
wherein the polymeric material is a water-absorbing polymer.

7. The humidity conditioning material according to claim 5,
wherein the humidity conditioning material has a core-shell structure including: a core containing the humidity conditioning liquid; and
the holding portion formed of the polymeric material and shaped into a shell.

8. A humidity conditioning device, comprising:
the humidity conditioning material according to claim 1; and
a housing portion housing the humidity conditioning material,
wherein the housing portion is at least partially transparent to light.

9. A method for manufacturing a humidity conditioning material, the method comprising:
a step of preparing a humidity conditioning liquid to include a hygroscopic substance containing a hygroscopic metal salt and a pH indicator configured to change in color in accordance with a concentration of the hygroscopic substance with respect to an amount of moisture contained in the humidity conditioning liquid;
a step of obtaining a liquid mixture in which a polymeric material is mixed with the humidity conditioning liquid, the polymeric material reacting with a gelling agent to form a gel;
a step of dripping the liquid mixture into the gelling agent to obtain particles; and
a step of freeze-drying the particles, wherein
the color changes in accordance with an increase or decrease in the concentration.
